(19) United States
(12) Patent Application Publication
(10) Pub. No.: US 2006/0153353 A1
(43) Pub. Date: Jul. 13, 2006

(54) Intelligent secondary call treatment for advanced calling scenarios

(76) Inventor: Douglas O'Neil, Marietta, GA (US)

Correspondence Address: BELLSOUTH CORPORATION, P.O. BOX 2903, MINNEAPOLIS, MN, 55402-0903, US

(21) Appl. No.: 11/140,807

(22) Filed: May 31, 2005

Related U.S. Application Data
(60) Provisional application No. 60/642,305, filed on Jan. 7, 2005.

(51) Int. Cl. H04M 3/42

(52) U.S. Cl. 379/211.02

(57) ABSTRACT

Systems and methods for providing intelligent secondary call treatment for advanced calling scenarios are provided. A communication directed to a subscriber address is received. The subscriber address is associated with an advanced calling feature. The communication is sent to the subscriber address and other addresses associated with the subscriber address in accordance with the advanced calling feature. Each of the address is associated with a secondary call treatment. If the communication is not answered by one of the addresses within a predetermined amount of time, then the secondary call treatment associated with the subscriber address is provided to the communication. The advanced calling feature may include call forwarding service, simultaneous calling service, or sequential calling service.

### CROSS REFERENCE TO RELATED APPLICATIONS

The present application claims priority under 35 U.S.C. § 119(e) to co-pending U.S. provisional application Ser. No. 60/642,305 entitled “Intelligent Secondary Call Treatment for Advanced Calling Scenarios” filed on Jan. 7, 2005, and which is expressly incorporated herein by reference.

### FIELD OF THE INVENTION

The present invention relates generally to providing intelligent secondary call treatment and, more particularly, to providing intelligent secondary call treatment for advanced calling scenarios.

### BACKGROUND OF THE INVENTION

Users have embraced various forms of advanced calling features such as call forwarding service, simultaneous ring service, and sequential ring service. However, complications arise in providing secondary call treatment when these advanced calling features are selected. For example, if a subscriber of call forwarding service selects to have all calls directed to the subscriber's home number forwarded to a relative's home number, and a call directed to the subscriber's home number goes unanswered, the relative's voicemail or answering machine will answer the call. This confuses the caller because the caller expects to be provided with secondary call treatment associated with the subscriber's home number, but instead is provided with secondary call treatment associated with the relative's home number. Moreover, the relative receives and is able to review a message intended for the user, and the subscriber is likely to miss the message altogether.

With regards to simultaneous ring service, a subscriber sets the simultaneous ring service to simultaneously ring a number of devices associated with the subscriber when a call directed to one of the devices is received. For example, the subscriber may set the subscriber's home phone, mobile phone, and office phone to ring simultaneously when a call directed to the subscriber's home phone is received. Typically, each of the numbers associated with the devices is associated with a secondary call treatment in the form of voicemail. Also, each voicemail is set to answer a call after a specific number of rings, such as three, except when the mobile phone is powered off, in which case the mobile phone's voicemail answers the call immediately after the call is received at the mobile phone. If a call directed to the subscriber's home phone is received when the subscriber's mobile phone is powered off, then the subscriber's home phone, mobile phone, and the office phone are rung simultaneous, but since the subscriber's mobile phone is powered off, the voicemail associated with the mobile phone answers the call immediately. As a result, the subscriber does not have the opportunity to answer the call on either the subscriber's home or office phone, and the subscriber is inconvenienced by having to check the voicemail on each of the phones to know that a message was received. In addition, the caller is again confused because the caller expects to be provided with secondary call treatment associated with the subscriber's home phone, but instead is provided with secondary call treatment associated with the subscriber's mobile phone.

Similarly, each of the voicemails associated with the subscriber's phones to be rung simultaneously may be set to answer a call after three rings. However, different telecommunications networks often require different amounts of time to “setup” a call. For instance, the time for a cellular network to “setup” a call to the subscriber's mobile phone may be three seconds for the first ring and five seconds between rings. The time for the landline network to “setup” a call to the subscriber's home and office phones is four seconds for the first ring and six seconds between rings. When a call directed to the subscriber's home phone is received, the subscriber's home phone, mobile phone, and office phone will be rung simultaneously. However, due to the differences in call “setup” times among the telecommunication networks, the voicemail associated with the subscriber's mobile phone will answer the call before the voicemail associated with the subscriber's home phone number. Again, the caller is confused because the caller expects to be provided with secondary call treatment associated with the subscriber's home phone, but instead is provided with secondary call treatment associated with the subscriber's mobile phone, and the subscriber is inconvenienced by having to check the voice mail on each of the phones to know that a message was received.

Currently, some telecommunications service providers offer a common secondary call treatment for all numbers associated with a subscriber. However, this common secondary call treatment requires coordination across different telecommunications networks and fails to address the different call “setup” times required by each network.

### SUMMARY OF THE INVENTION

In accordance with the present invention, the above and other problems are addressed by systems and methods for providing intelligent secondary call treatment for advanced calling scenarios. When a call forwarded to a subscriber directory address and a plurality of directory addresses associated with the subscriber directory address in accordance with an advanced calling feature goes unanswered, the call is forwarded to a Secondary Call Treatment Application Server that provides secondary call treatment for the call.

According to an embodiment of the method, a communication directed to a subscriber address is received. The subscriber address is associated with an advanced calling feature. The communication is sent to the subscriber address and other addresses associated with the subscriber address in accordance with the advanced calling feature. Each of the addresses is associated with a secondary call treatment. If the communication is not answered by one of the addresses within a predetermined amount of time, then the secondary call treatment associated with the subscriber address is provided to the communication. The advanced calling feature may include call forwarding service, simultaneous calling service, or sequential calling service.

The method may further include preventing the secondary call treatment associated with the at least one address from answering the communication if the secondary call treatment associated with the at least one address attempts to answer the communication within the predetermined amount of time. If the secondary call treatment associated with the at least one address attempts to answer the communication, then the communication is routed to an application server. The communication is provided with the secondary call treatment associated with the subscriber address.

In accordance with another embodiment of the present invention, a secondary call treatment application associated with a secondary call treatment server is received, and a communication directed to a subscriber address associated with an advanced calling feature is received. The communication is sent to the subscriber address and to at least one address associated with the subscriber address in accordance with the advanced calling feature. Each of the addresses is associated with a secondary call treatment. If the communication is not answered within a predetermined amount of time by one of the addresses, then the communication is forwarded to the secondary call treatment server. The communication is provided with the secondary call treatment application associated with the secondary call treatment server.

The method may further include preventing the secondary call treatment associated with the at least one address from answering the communication if the secondary call treatment associated with the at least one address attempts to answer the communication within the predetermined amount of time. If the secondary call treatment associated with the at least one address attempts to answer the communication, then the communication is routed to the secondary call treatment server. The communication is provided with the secondary call treatment application associated with the secondary call treatment server.

According to an embodiment of the system, a network element receives a communication directed to a subscriber address associated with an advanced calling feature. The network element provides the communication to a first application server. In accordance with the advanced calling feature, the first application server sends the communication to the subscriber address and to at least one address associated with the subscriber address. Each of the addresses is associated with a secondary call treatment. If the communication is not answered within a predetermined amount of time by one of the addresses, then the first application server forwards the communication to a second application which provides the communication with the secondary call treatment associated with the subscriber address.

If the secondary call treatment associated with the at least one address attempts to answer the communication within the predetermined amount of time, the first application server may prevent the secondary call treatment associated with the at least one address from answering the communication by forwarding the communication to the second application server.

### BRIEF DESCRIPTION OF THE DRAWINGS

FIG. 1 is a block diagram of a system for providing intelligent secondary call treatment for advanced calling scenarios according to an embodiment of the present invention.

FIGS. 2A-2C are flow diagrams showing an illustrative process for providing intelligent secondary call treatment for advanced calling scenarios according to an embodiment of the present invention.

### DETAILED DESCRIPTION OF THE PREFERRED EMBODIMENT

Embodiments of the present invention provide for systems and methods for providing intelligent secondary call treatment for advanced calling scenarios. When a call forwarded to a subscriber directory address and a plurality of directory addresses associated with the subscriber directory address in accordance with an advanced calling feature goes unanswered, the call is forwarded to a Secondary Call Treatment Application Server that provides secondary call treatment for the call. In the following detailed description, references are made to the accompanying drawings that form a part hereof, and in which are shown by way of illustration specific embodiments or examples. Referring now to the drawings, in which like numerals represent like elements through the several figures, aspects of the present invention and the exemplary operating environment will be described.

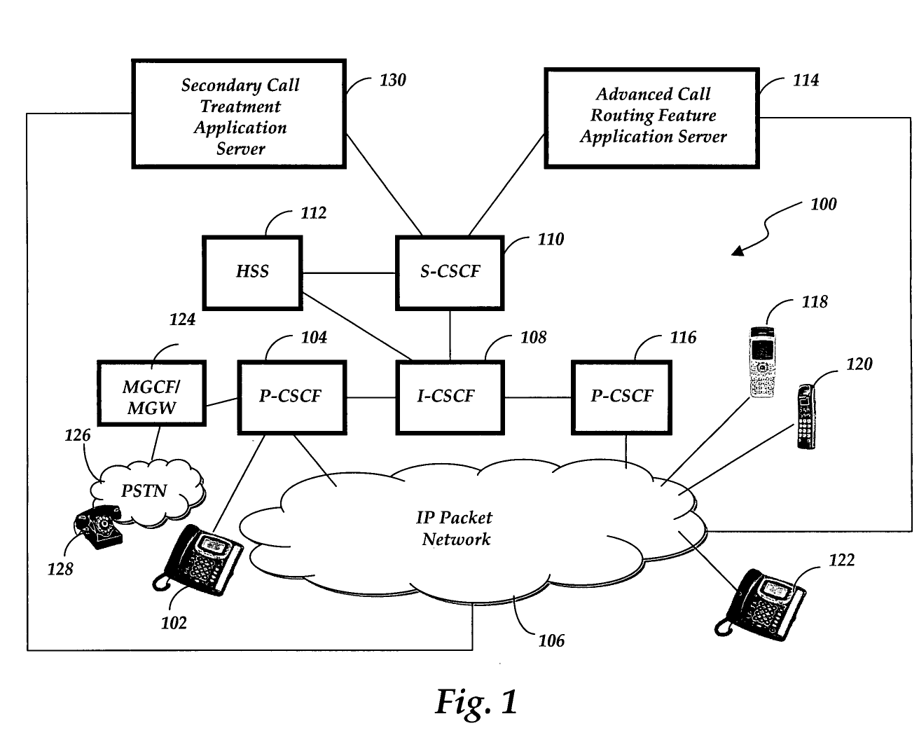

FIG. 1 is a block diagram illustrating components of an Internet Protocol (IP) network that provides an exemplary operating environment for the present invention. In a preferred embodiment, the IP network comprises an Internet Protocol Multimedia Subsystem (IMS) network 100. The IMS network 100 is a set of standards developed by the 3rd Generation Partnership Project (3GPP) that supports a wide range of services enabled by IP based protocol such as, for example, Session Initiation Protocol (SIP). The IMS network 100 supports multiple application servers that supply a variety of services during a communication session and provides instructions that define the conditions and logic under which the application servers should be engaged in the communication session. Some of the components of the IMS 100 are illustrated in FIG. 1.

Each user equipment (UE) device 102, 118, 120, 122 in the IMS network 100 is preferably assigned a directory address. The term “directory address” is used herein to reference a telephone number or an IP address that is input by a calling party at an originating UE to reach a terminating UE associated with the directory address.

The UE device 102 associated with a calling party may include devices capable of supporting IP based signaling, such as a SIP phone, or multimedia devices, such as a video streaming application server. The UE device 122 associated with the called party's directory address input by the calling party includes devices capable of supporting IP based signaling, such as a SIP phone. UE devices 118, 120, and 128 associated with the UE device 122 may include devices capable of supporting IP based signaling or devices connected to the public switched telephone network (PSTN) 126.

A plurality of Call Session Control Functions (CSCFs) are provided in a typical IMS network 100, as illustrated in FIG. 1. CSCFs perform signaling operations for communication session control. The CSCFs manage communication sessions and coordinate with other network entities for session control, service control, and resource allocation. As shown in FIG. 1, these CSCFs include Proxy-CSCFs (P-CSCFs) 104 and 116, Interrogating-CSCF (I-CSCF) 108, and Serving-CSCF (S-CSCF) 110. The P-CSCF 104 receives a SIP message, such as a SIP invite message, from a calling party directed to a called party and forwards the SIP invite message to the S-CSCF 110 serving the calling party. If the P-CSCF 104 does not know the location of the S-CSCF 110 serving the calling party, then the P-CSCF 104 forwards the message to the I-CSCF 108 which determines the address of the appropriate S-CSCF 110, as described below. The P-CSCF 116 forwards the SIP invite message to the called party to establish a communication session between the calling party and the called party.

If the P-CSCF 104 forwards the SIP invite message to the I-CSCF 108, the I-CSCF 108 queries a Home Subscriber Server (HSS) 112 to determine the address of the S-CSCF 110 serving the calling party as well as the address of the UE device 122 associated with the called party based on the directory address input by the calling party. The HSS 112 is a database that maintains service profiles associated with each subscriber to the IMS network 100. A service profile contains subscriber information and preferences including a subscriber's current registration information, subscriber's roaming information, subscriber's advanced calling features, and subscriber's services such as, for example, information regarding intelligent secondary call treatment service of the present invention. The HSS 112 also maintains locations of the application servers associated with a subscriber's services to be engaged to assist in providing the subscriber's services during setup of the communication session. Further, the HSS 112 provides the filter criteria, or set of instructions, that define the condition and logic under which the application servers associated with the subscriber's service should be engaged during setup of the communication session.

Once the I-CSCF 108 has received the address of the S-CSCF 110 serving the calling party and the address of the UE device 122 associated with the called party from the HSS 112, the I-CSCF 108 forwards the SIP invite message including the address of the UE device 122 to the S-CSCF 110. Additionally, caller identification (caller ID) information is forwarded along with the forwarded SIP invite message to the S-CSCF 110. The S-CSCF 110 performs session control services for the parties involved in the communication session. Upon receipt of the SIP invite message, the S-CSCF 110 queries the HSS 112 for service information, filter criteria, and addresses of the application severs associated with the called party's services. Additionally, if the application servers associated with the called party's service include multiple applications, the HSS 112 provides the S-CSCF 110 with a code designating which application to apply. The S-CSCF 110 engages the application servers associated with the called party's services in accordance with the filter criteria provided by the HSS 112. If the called party subscribes to the intelligent secondary call treatment service of the present invention, then the HSS 112 instructs the S-CSCF 110 to engage an Advanced Call Routing Feature Application server 114, and if no SIP acknowledgement message is received from a called party's user equipment (UE) device or UE devices associated with the called party within a predetermined amount of time, then to engage a Secondary Call Treatment Application Server 130, as discussed below.

The Advanced Call Routing Feature Application Server 114 is an application server that provides terminating call services according to the services subscribed to by the called party. These terminating call services include advanced calling features such as, for example, simultaneous ringing service, sequential ringing service, call forwarding service, and video streaming multimedia service. In addition, the Advanced Call Routing Feature Application Server 114 maintains a table of all the directory addresses of the UE devices 118, 120, and 128 associated with the subscriber UE device 122 in accordance with the subscriber's advanced calling feature as well as the corresponding networks that serve each of the UE devices. The Advanced Call Routing Feature Application Server 114 forwards the SIP invite message from the calling party to the UE device 122 associated with the input directory address and the UE devices 118, 120, and 128 associated with the input directory address in accordance with the advanced calling feature. For example, if the called party subscribes to simultaneous ringing service, then the Advanced Call Routing Feature Application Server 114 forwards the SIP invite message to the UE device 122 associated with the called party's directory address input by the calling party and to the UE devices 118, 120, and 128 designated by the called party to be rung simultaneously with the UE device 122. SIP invite messages are sent to the UE devices 118 and 120 via an IP packet network 106 such as, for example, the Internet or any other network capable of transferring data in packets. To provide the SIP invite message to the UE device 128 associated with the PSTN 126, a media gateway control function/media gateway (MGCF/MGW) element 124 converts the SIP invite message to a format that the PSTN understands, such as SS7 ISUP signaling.

If, after a predetermined amount of time defined by the filter criteria, a SIP acknowledgement message is not received from one of the UE devices 118, 120, 122, or 128 or a call reject message is received from all of the UE devices, then the S-CSCF 110 forwards the SIP invite message along with the called party's directory address input by the calling party to the Secondary Call Treatment Application Server 130 as instructed by the HSS 112. The Secondary Call Treatment Application Server 130 is an application server that provides secondary call treatment to the calling party. In an embodiment of the present invention, the Secondary Call Treatment Application Server 130 maintains a table of each of the called party's UE devices and the secondary call treatment associated with each of the devices. When the Secondary Call Treatment Application Server 130 receives the SIP invite message and the called party's address input by the calling party, the Server 130 provides the calling party with the secondary call treatment associated with the called party's directory address input by the calling party and stores any voice message left by the calling party. The secondary call treatment associated with the called party's address may include voice mail, unified messaging, or video stream storage. In an alternative embodiment of the present invention, the Secondary Call Treatment Application Server 130 may provide the calling party with a secondary call treatment application defined by the called party, regardless of the directory number address input by the calling party. The called party may define the secondary call treatment application associated with the server 130 by calling a number associated with the Server 130 or through a web interface associated with the Server 130. A called party may access and review voice messages stored at the Server 130 by calling the number associated with the Server 130 or by accessing the web interface associated with the Server 130.

In an embodiment of the present invention, if, during the predetermined amount of time, one of the UE devices 118, 120, 122, or 128 sends a message to the Advanced Call Routing Feature Application Server 114 indicating that the SIP invite message is being forwarded to the secondary call treatment associated with one of the UE devices 118, 120, 122, or 128, then the S-CSCF 110 forwards the SIP invite message along with the called party's address input by the calling party to the Secondary Call Treatment Application Server 130, overriding the secondary call treatment associated with the UE devices.

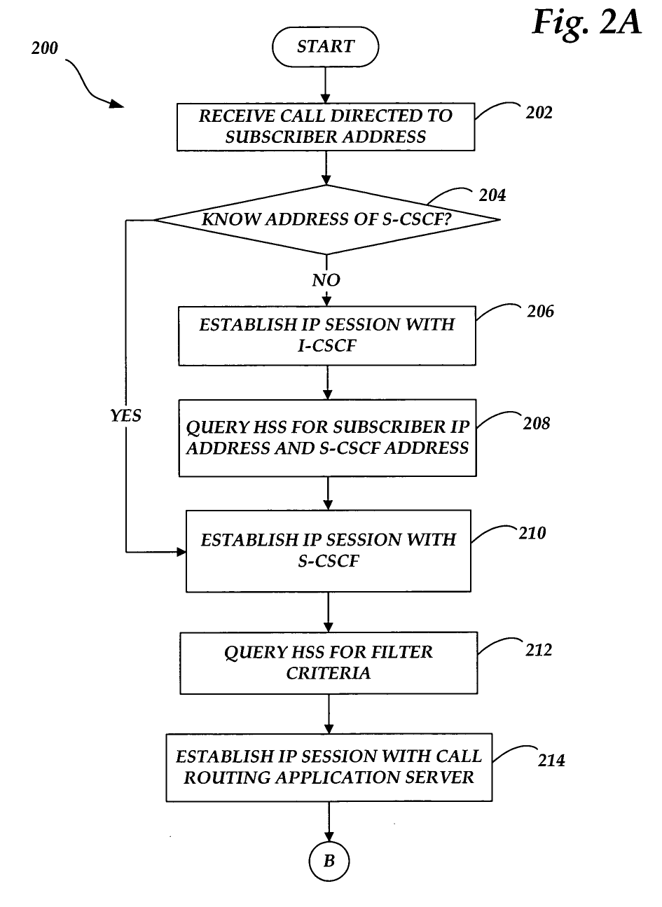

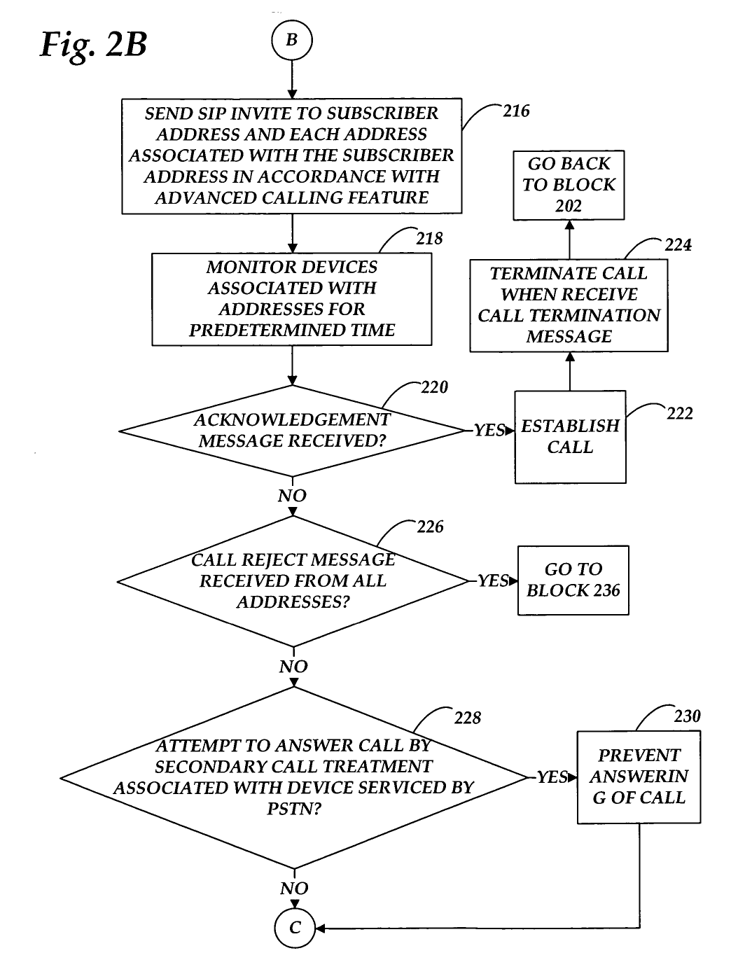

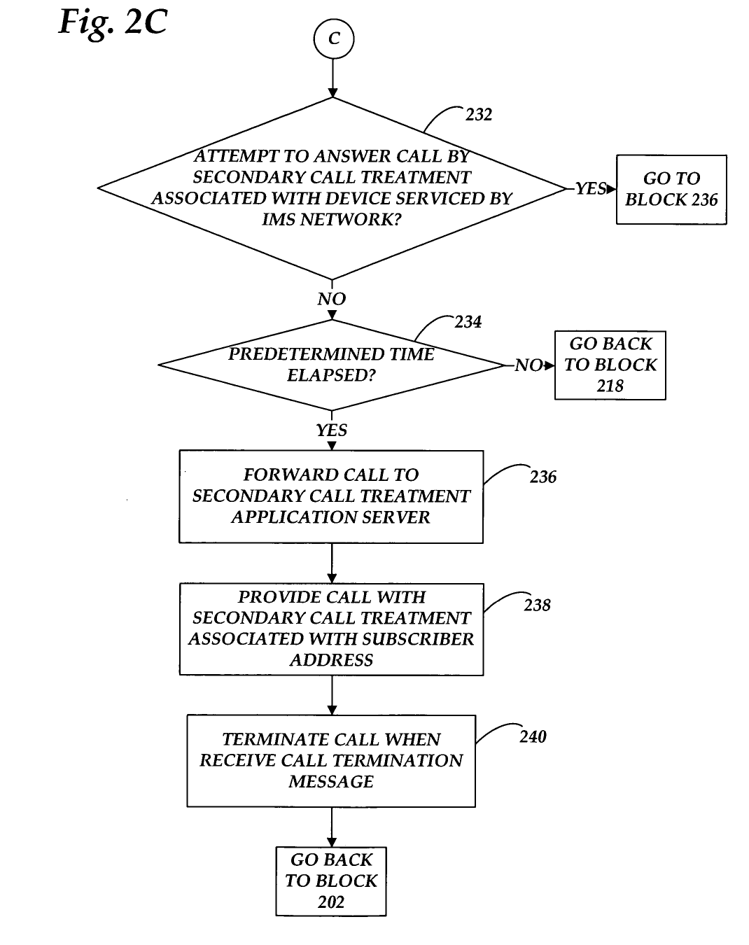

Having described an exemplary environment of the present invention with reference to FIG. 1, FIGS. 2A-2C illustrates an operational flow of the a process 200 for providing intelligent secondary call treatment for advanced calling scenarios according to an embodiment of the present invention. The process 200 begins at block 202 where the P-CSCF 104 receives a SIP invite message from a UE device 102 associated with a calling party directed to a UE device 122 associated with a called party that subscribes to the intelligent secondary call treatment service of the present invention. The calling party either dials the number associated with the subscriber UE device 122 or initiates an IP session to the IP address associated with the subscriber UE device 122. In an embodiment of the present invention, the number or IP address corresponding to the subscriber UE device 122 is associated with an advanced calling feature such as, for example, call forwarding service, simultaneous ringing service, or sequential ringing service. When a call directed to the number or IP address corresponding to the subscriber UE device 122 is received, the call is forwarded to the subscriber UE device 122 as well as the UE devices 118, 120, and 128 associated with the subscriber UE device 122 in accordance with the advanced calling feature.

From block 202, the process 200 proceeds to block 204, where a determination is made whether the P-CSCF 104 knows the IP address of the S-CSCF 110 serving the UE device 102. If the P-CSCF 104 does know the address of the S-CSCF 110, then the process 200 proceeds to block 210. However, if the P-CSCF 104 does not know the IP address of the S-CSCF 110, then the process 200 proceeds to block 206, where the P-CSCF 104 engages an IP session with the I-CSCF 108. From block 206, the process 200 proceeds to block 208 where the I-CSCF queries the HSS 112 to determine the IP address of the S-CSCF 110 and the IP address corresponding to the subscriber UE device 122. Once the I-CSCF 108 receives the information from the HSS 112, then the process 200 proceeds to block 210.

At block 210, an IP session is established with the S-CSCF 110 by forwarding the SIP invite message to the S-CSCF 110 along with call related information including caller ID and the number and IP address associated with the subscriber UE device 122. From block 210, the process 200 proceeds to block 212 where the S-CSCF 110 queries the HSS 112 for the filter criteria associated with the subscriber. As discussed above, the filter criteria identifies the different application servers that are to be engaged during setup of the call. Moreover, the filter criteria includes the set of instructions that defines the conditions and logic under which the identified application servers should be engaged during the call setup. From the service profile associated with the received number and IP address of the subscriber UE device 122, the HSS 112 determines that the called party subscribes to both an advanced calling feature, such as simultaneous ringing service, and the intelligent secondary call treatment service of the present invention. Therefore, the HSS 112 instructs the S-CSCF 110 to engage the Advanced Call Routing Feature Application Server 114 and to provide the Server 114 with the number and/or IP address associated with the subscriber UE device 122 and, if the Server 114 includes multiple applications, a code designating the Advanced Call Routing Feature Application to be applied. In an embodiment of the present invention, a subscriber may subscribe to a number of advanced calling features. A subscriber may select the advanced calling feature to be enabled or disabled at any time by calling a number associated with the HSS 112 or accessing a web interface associated with the HSS 112. Based on this information, the HSS provides the code designating the Advanced Call Routing Feature Application enabled by the subscriber to the S-CSCF 110 with instructions to provide the code to the Server 114. The HSS 112 also provides the IP address of the Server 114 to the S-CSCF 110.

The HSS 112 further instructs the S-CSCF 110 to engage the Secondary Call Treatment Application Server 130 and to provide the Server 130 with the number and/or IP address associated with the subscriber UE device 122 and, if the Server 130 includes multiple applications, a code designating the Secondary Call Treatment Application to be applied if the Advanced Call Routing Feature Application Server 114 returns a message that a SIP acknowledgement message has not been received from any of the UE devices 118, 120, 122, or 128 associated with the subscriber within a predetermined amount of time, such as 15 seconds, or if the Server 114 returns a message that call reject messages have been received from all of the UE devices 118, 120, 122, and 128 associated with the subscriber. The HSS 112 provides the IP address of the Secondary Call Treatment Application Server 130 to the S-CSCF 110 and, if applicable, the code designating the application to be applied. In another embodiment of the present invention, the Advanced Call Routing Feature Application Server 114, instead of the HSS 112, may provide the S-CSCF 110 with instructions regarding engaging the Secondary Call Treatment Application Sever 130 if a SIP acknowledgement message is not received from any of the UE devices 118, 120, 122, or 128 within a predetermined amount of time, or if a call reject message is received from all of the UE devices 118, 120, 122, and 128.

Furthermore, the HSS 112 instructs the S-CSCF 110 to engage the Secondary Call Treatment Application Server 130 and to provide the Server 130 with the number and/or IP address associated with the subscriber UE device 122 and, if applicable, a code designating the application to be applied if, during the predetermined amount of time, the Advanced Call Routing Feature Application Server 114 returns a message that a SIP message has been received from one of the subscriber UE devices 118, 120, or 122 serviced by the IMS network 100 indicating that one of the subscriber UE devices has attempted to forward the call to a secondary call treatment associated with that UE device. Thus, the UE devices 118, 120, and 122 associated with the called party are denied from providing secondary call treatment such as, for example, voice mail or video stream storage, for the call. In another embodiment of the present invention, the Advanced Call Routing Feature Application Server 114, instead of the HSS 112, may provide the S-CSCF 110 with instructions regarding engaging the Secondary Call Treatment Application Sever 130 if a SIP message has been received from one of the subscriber UE devices 118, 120, or 122 serviced by the IMS network 100 indicating that one of the subscriber UE devices has attempted to forward the call to a secondary call treatment associated with that UE device.

From block 212, the process 200 proceeds to block 214, where the S-CSCF 110 establishes an IP session with the Advanced Call Routing Feature Application Server 114 and provides the Server 114 with the number and/or IP address associated with the subscriber UE device 122 and, if applicable, the code designating the application be applied. Based on the information received from the S-CSCF 110, the Server 114 determines that the number and/or IP address corresponding to the subscriber UE device 122 is associated with an advanced calling feature. In an embodiment of the present invention, the advanced calling feature is simultaneous ringing service. The Server 114 maintains a list of UE devices 118, 120, and 128 associated with the subscriber UE device 122 as well as the type of network that serves each UE device. In an embodiment of the present invention, the UE devices 118, 120, and 122 are served by the IMS network 100, and the UE device 128 is served by the PSTN network 126.

From block 214, the process 200 proceeds to block 216 where, in accordance with the simultaneous ringing service, the Server 114 sends SIP invite messages to the subscriber UE device 122, to the UE devices 118 and 120 via the P-CSCF 116 and the IP packet network 106, and to the UE device 128 via the MGCF/MGW 124 and PSTN network 126. From block 216, the process 200 proceeds to block 218 where the Server 114 monitors the UE devices 118, 120, 122, and 128 for a predetermined amount of time based on the information provided by the S-CSCF 110. The process 200 then proceeds to block 220 where a determination is made whether the Server 114 has received a SIP acknowledgement message from one of the UE devices 118, 120, 122, or 128 during the predetermined amount of time indicating that the call is being answered. If a SIP acknowledgement message is received from one of the UE devices 118, 120, 122, or 128, then the process 200 proceeds to block 222 where a call is established between the calling party and the UE device that sends the SIP acknowledgement message, and the Server 114 instructs the S-CSCF 110 to wait for a call termination message. From block 222, the process 200 proceeds to block 224 where the call termination message is received, and the call is terminated. From block 224, the process 200 proceeds back to block 202.

If, at block 220, the Server 114 has not received a SIP acknowledgement message from one of the UE devices 118, 120, 122, or 128, then the process 200 proceeds to block 226, where a determination is made whether the Server 114 has received a call reject message from each of the UE devices 118, 120, 122, and 128 indicating that each of the devices is currently being used. If the Server 114 has received a call reject message from each of the UE devices 118, 120, 122, and 128, then the Server 114 returns a message to the S-CSCF 110 that the call has not been answered, and the process 200 proceeds to block 236 where the S-CSCF 110 forwards the call to the Secondary Call Treatment Application Server 130 per the instructions provided by the HSS 112 or the Server 114.

If, at block 226, the Server 114 has not received a call reject message from each of the UE devices 118, 120, 122, and 128, then the process 200 proceeds to block 228 where a determination is made whether the Server 114 has received a SIP answer message (200 OK) from the MGCF/MGW 124 that serves the UE device 128 serviced by the PSTN network 126 indicating that the UE device 128 has either answered the call or forwarded the call to the secondary call treatment associated with the UE device 128. The Advanced Call Routing Feature Application Server 114 includes a PSTN Call Answer Identification Application that the Server 114 invokes to check if the call has been answered by the secondary call treatment associated with the UE device 128 such as, for example, a voice mail system or an answering machine. When a user subscribes to the intelligent secondary call treatment service of the present invention, the user provides the Server 114 with a list of the voice mail systems associated with all the UE devices serviced by the PSTN as well as the phone numbers and passwords associated with the voice mail systems. The user also provides an indication to the Server 114 whether any of the UE devices is associated with an answering machine. A subscriber to the intelligent secondary call treatment service may provide this information by calling a number associated with the Server 114 or through a web interface associated with the Server 114. The PSTN Call Answer Identification Application of the Server 114 then calls each voice mail system and/or answering machine and records the subscriber's greeting or the first seconds of the subscriber's greeting. When the Server 114 receives a SIP answer message (200 OK) from the MGCF/MGW 124 that serves the UE device 128 serviced by the PSTN network 126 indicating that the UE device 128 has either answered the call or has forwarded the call to the secondary call treatment associated with the UE device 128, the PSTN Call Answer Identification Application determines if the call has been answered by a voice mail system or answering machine designated by the subscriber by comparing the current greeting with the recorded greetings. If the first seconds of the current greeting match the first seconds of the recorded greeting, then the PSTN Call Answer Identification Application indicates that the secondary call treatment associated with the UE device 128 should be denied, and the process 200 proceeds to block 230 where the Server 114 denies the connection of the call with the secondary call treatment associated with the UE device 128 and continues ringing the UE devices 118, 120, and 122. From block 230, the process 200 proceeds to block 232.

If, at block 228, the Server 114 has not received a SIP answer message (200 OK) from the MGCF/MGW 124 that serves the UE device 128, then the process 200 proceeds to block 232 where a determination is made whether the Server 114 has received a SIP message from one of the UE devices 118, 120, or 122 serviced by the IMS network 100 indicating that one of the UE devices 118, 120, or 122 is attempting to forward the call to a secondary call treatment associated with one of the UE devices 118, 120, or 122. If the Server 114 has received such a SIP message from one of the UE devices 118, 120, or 122, then the Server 114 returns a message to the S-CSCF 110 that an attempt has been made to forward the call to a secondary call treatment associated with one of the UE device 118, 120, or 122, and the process 200 proceeds to block 236 where the S-CSCF 110 forwards the call to the Secondary Call Treatment Application Server 130 per the instructions provided by the HSS 112 or Server 114. If, on the other hand, the Server 114 has not received a SIP message from one of the UE devices 118, 120, or 122, then the process 200 proceeds to block 234 where a determination is made whether the predetermined amount of time to connect the call has elapsed. If the predetermined amount of time has not elapsed, then the process 200 proceeds back to block 218 where the Advanced Call Routing Feature Application Server 114 continues to monitor the UE devices 118, 120, 122, and 128. If the predetermined amount of time to connect the call has elapsed, then the Server 114 sends a message to the S-CSCF 110 that the call has not been answered, and the process 200 proceeds to block 236.

At block 236, the S-CSCF 110 forwards the call to the Secondary Call Treatment Application Server 130 per the instructions provided by the HSS 112 or the Server 114. From block 236, the process 200 proceeds to block 238 where the Server 130 provides secondary call treatment for the call. The Server 130 maintains a table of each of the called party's UE devices 118, 120, 122, and 128 and the secondary call treatment associated with each of the devices. In one embodiment, the Server 130 provides the secondary call treatment associated with the input number and/or IP address corresponding to the subscriber UE device 122 to the calling party. Therefore, the calling party is provided with the expected secondary call treatment instead of one of the secondary call treatments associated one of UE devices 118, 120, or 128 associated with the subscriber UE device 122. The secondary call treatment associated with the called party's address may include voice mail, unified messaging, video stream storage, or any other treatment operative to store a message from a calling party. In an alternative embodiment, the Server 130 may provide the secondary call treatment application defined by the called party and associated with the Server 130, regardless of the directory number address input by the calling party, such as a common voice mailbox. In another embodiment of the present invention, the functionality of the Secondary Call Treatment Application Server 130 may reside at the Advanced Call Routing Feature Application Server 114 such that if a call reject message is received from each of the UE devices 118, 120, 122, and 128, a SIP answer message is received from one of the UE devices 118, 120, 122, or 128 indicating that the device is attempting to forward the call to the secondary call treatment associated with the UE device, or a SIP answer message is not received within the predetermined amount of time, then the Sever 114 provides the secondary call treatment to the calling party.

From block 238, the process 200 proceeds to block 240 where the S-CSCF 110 terminates the session between the calling party and the Server 130 upon receiving a termination message from the Server 130. The S-CSCF 110 then sends the termination message to the I-CSCF 108, which in turn, sends the termination message to the P-CSCF 104. The process 200 then proceeds back to block 202.

We claim:

1. A method for providing secondary call treatment, comprising:
receiving a communication directed to a subscriber address, wherein the subscriber address is associated with an advanced calling feature;
sending the communication to the subscriber address and to at least one address associated with the subscriber address in accordance with the advanced calling feature, wherein each of the subscriber address and the at least one address is associated with a secondary call treatment; and
if the communication is not answered within a predetermined amount of time by one of the addresses, then providing the communication with the secondary call treatment associated with the subscriber address.

2. The method of claim 1, further comprising if the secondary call treatment associated with the at least one address attempts to answer the communication within the predetermined amount of time, then preventing the secondary call treatment associated with the at least one address from answering the communication.

3. The method of claim 2, wherein preventing the secondary call treatment associated with the at least one address from answering the communication includes:
routing the communication to an application server; and
providing the communication with the secondary call treatment associated with the subscriber address.

4. The method of claim 1, wherein the subscriber address is a telephone number.

5. The method of claim 1, wherein the subscriber address is an Internet Protocol address.

6. The method of claim 1, wherein the advanced calling feature includes a call forwarding service.

7. The method of claim 1, wherein the advanced calling feature includes a simultaneous ringing service.

8. The method of claim 1, wherein the advanced calling feature includes sequential ringing service.

9. A method for providing secondary call treatment, comprising:
receiving a secondary call treatment application associated with a secondary call treatment server;
receiving a communication directed to a subscriber address, wherein the subscriber address is associated with an advanced calling feature;
sending the communication to the subscriber address and to at least one address associated with the subscriber address in accordance with the advanced calling feature, wherein each of the subscriber address and the at least one address is associated with a secondary call treatment;
if the communication is not answered within a predetermined amount of time by one of the addresses, then forwarding the communication to the secondary call treatment server; and
providing the communication with the secondary call treatment application associated with the secondary call treatment server.

10. The method of claim 9, further comprising if the secondary call treatment associated with the at least one address attempts to answer the communication within the predetermined amount of time, then preventing the secondary call treatment associated with the at least one address from answering the communication.

11. The method of claim 10, wherein preventing the secondary call treatment associated with the at least one address from answering the communication includes:
routing the communication to the secondary call treatment server; and
providing the communication with the secondary call treatment application associated with the secondary call treatment server.

12. The method of claim 9, wherein the subscriber address is a telephone number.

13. The method of claim 9, wherein the subscriber address is an Internet Protocol address.

14. The method of claim 9, wherein the advanced calling feature includes a call forwarding service.

15. The method of claim 9, wherein the advanced calling feature includes a simultaneous ringing service.

16. The method of claim 9, wherein the advanced calling feature includes sequential ringing service.

17. A system for providing secondary call treatment, comprising:
a network element operative to:
receive a communication directed to a subscriber address, wherein the subscriber address is associated with an advanced calling feature;
provide the communication to a first application server;
the first application server operative to:
send the communication to the subscriber address and to at least one address associated with the subscriber address in accordance with the advanced calling feature, wherein each of the subscriber address and the at least one address is associated with a secondary call treatment;
if the communication is not answered within a predetermined amount of time by one of the addresses, then forward the communication to a second application server; and
the second application server further operative to:
provide the communication with the secondary call treatment associated with the subscriber number.

18. The system of claim 17, wherein the first application server is further operative to prevent the secondary call treatment associated with the at least one address from answering the communication if the secondary call treatment associated with the at least one address attempts to answer the communication within the predetermined amount of time.

19. The system of claim 17, wherein the first application server is further operative to forward the communication to the second application server if the secondary call treatment associated with the at least one address attempts to answer the communication within the predetermined amount of time.

20. The system of claim 17, wherein the network element includes a serving call session control function.
